(19) United States
(12) Patent Application Publication
(10) Pub. No.: US 2023/0030368 A1
(43) Pub. Date: Feb. 2, 2023

(54) VEHICLE CONTROL DEVICE

(71) Applicant: Mitsubishi Electric Corporation, Tokyo (JP)

(72) Inventors: Tomoki UNO, Tokyo (JP); Rin ITO, Tokyo (JP)

(73) Assignee: Mitsubishi Electric Corporation, Tokyo (JP)

(21) Appl. No.: 17/789,542

(22) PCT Filed: Mar. 13, 2020
(86) PCT No.: PCT/JP2020/011041

§ 371 Date: Jun. 28, 2022

(51) Int. Cl. B60W 50/02

(52) U.S. Cl. CPC B60W 50/0225; B60W 50/0205; B60W 2520/00; B60W 2552/00; B60W 10/18

(57) ABSTRACT

In a vehicle control device, a reference route generator obtains point-series information including information on sets of coordinates through which a subject vehicle needs to travel, and approximates, by polynomials each being a function of a route length from a preset reference point, a longitudinal position and a lateral position of the subject vehicle based on the sets of coordinates to generate a reference route represented by the polynomials. A planned traveling distance computing unit calculates a planned traveling distance being a distance that the subject vehicle needs to travel in a unit time of a predefined length. A target value computing unit calculates a target position being a target value of a position of the subject vehicle after the unit time, based on the polynomials of the longitudinal position and the lateral position of the subject vehicle, and the planned traveling distance.

### TECHNICAL FIELD

The present disclosure relates to a vehicle control device that performs automated driving of a vehicle or provides driving assistance.

### BACKGROUND ART

For example, Patent Document 1 below discloses a vehicle control device. This vehicle control device stores, for each point in time, a relative position of a preceding vehicle to be followed by a subject vehicle with respect to the subject vehicle, performs polynomial approximation of a series of the stored relative positions to calculate a route of the subject vehicle, and makes the subject vehicle travel along the calculated route to make the subject vehicle follow the preceding vehicle while traveling.

### Prior Art Document

### Patent Document

Patent Document 1: Japanese Patent Application Laid-Open No. 2019-131149

### SUMMARY

### Problem to be Solved by the Invention

The technology of Patent Document 1 has difficulty in making the subject vehicle precisely follow the preceding vehicle, for example, when the preceding vehicle is steered at a right angle (turns right or left) at an intersection or makes a U-turn. This is because the stored relative positions of the preceding vehicle greatly differ from the route obtained by the polynomial approximation. This causes the traveling route of the subject vehicle to deviate from the traveling route of the preceding vehicle. Thus, the passenger of the subject vehicle may feel uncomfortable.

The present disclosure has been conceived to solve the problems, and has an object of providing a vehicle control device that can precisely calculate a route through which the subject vehicle needs to travel, even when the subject vehicle is steered at a right angle or makes a U-turn.

### Means to Solve the Problem

A vehicle control device according to the present disclosure includes: a reference route generator to obtain point-series information including information on a plurality of sets of coordinates through which a subject vehicle needs to travel, and approximate, by polynomials, a longitudinal position and a lateral position of the subject vehicle based on the plurality of sets of coordinates to generate a reference route represented by the polynomials, each of the polynomials being a function of a route length from a preset reference point; a planned traveling distance computing unit to calculate a planned traveling distance that is a distance that the subject vehicle needs to travel in a unit time of a predefined length; a target value computing unit to calculate a target position that is a target value of a position of the subject vehicle after the unit time, based on the polynomial of the longitudinal position of the subject vehicle, the polynomial of the lateral position of the subject vehicle, and the planned traveling distance; and a vehicle controller to control an actuator of the subject vehicle so that an error between the position of the subject vehicle after the unit time and the target position is reduced.

### Effects of the Invention

According to the present disclosure, a reference route through which a subject vehicle needs to travel is calculated by approximating a longitudinal position and a lateral position of the subject vehicle by polynomials each of which is a function of a route length from a reference point. Even when the subject vehicle is steered at a right angle or makes a U-turn, the reference route can be precisely expressed.

The object, features, aspects and advantages of the present disclosure will become more apparent from the following detailed description and the accompanying drawings.

### BRIEF DESCRIPTION OF DRAWINGS

FIG. 1 is a block diagram illustrating a configuration of a vehicle control unit according to Embodiment 1.

FIG. 2 illustrates a schematic structure of a vehicle (subject vehicle) on which the vehicle control unit according to Embodiment 1 is mounted.

FIG. 3 is a flowchart illustrating operations of a reference route generator.

FIG. 4 illustrates an example of a plurality of sets of coordinates and a reference point in a subject-vehicle coordinate system.

FIG. 5 illustrates a relationship between a route length and an x coordinate (subject-vehicle longitudinal position) in each of the sets of coordinates in FIG. 4.

FIG. 6 illustrates a relationship between the route length and a y coordinate (subject-vehicle lateral position) in each of the sets of coordinates in FIG. 4.

FIG. 7 illustrates operations of a target value computing unit.

FIG. 8 is a block diagram illustrating a configuration of the vehicle control unit according to Embodiment 4.

FIG. 9 is a block diagram illustrating a configuration of the vehicle control unit according to Embodiment 5.

### DESCRIPTION OF EMBODIMENTS

### Embodiment 1

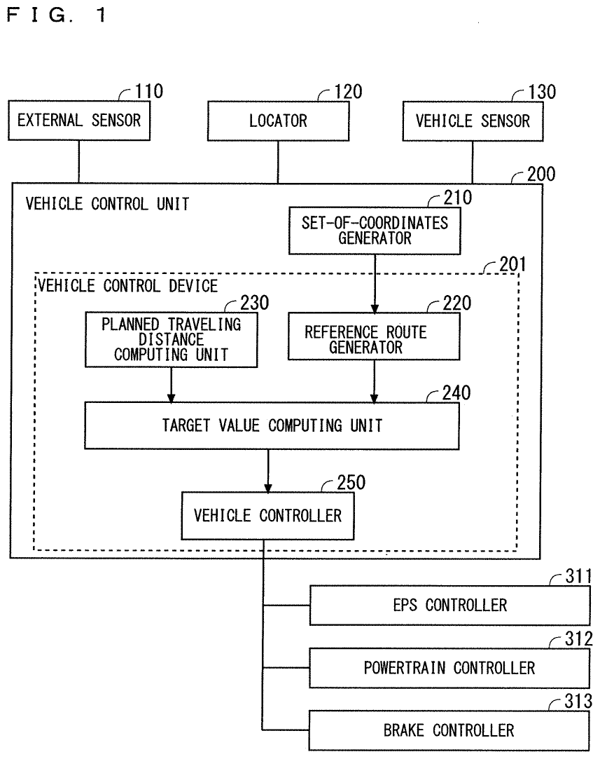

FIG. 1 is a block diagram illustrating a schematic configuration of a vehicle control unit 200 according to Embodiment 1. The vehicle control unit 200 is mounted on a vehicle, and is connected to an external sensor 110, a locator 120, a vehicle sensor 130, an Electric Power Steering (EPS) controller 311, a powertrain controller 312, and a brake controller 313 all of which are included in the vehicle. The vehicle on which the vehicle control unit 200 is mounted will be hereinafter referred to as a “subject vehicle”.

The external sensor 110 is a sensor that detects a position of, for example, an obstacle or a dividing line around the subject vehicle. The external sensor 110 includes, for example, a forward camera that detects a position, an angle, and a curvature of a road dividing line, and a radar that obtains a position and a speed of a preceding vehicle that the subject vehicle follows. Furthermore, the external sensor 110 may include a light detection and ranging (LiDAR), a sonar, an inter-vehicle communication device, and a roadside-to-vehicle communication device.

The locator 120 is a device that distributes map information on a road through which the subject vehicle needs to travel and the surrounding area, based on position information of the subject vehicle and map information. Examples of a method for the locator 120 to obtain the position information of the subject vehicle may include a method for calculating the position information from a positioning signal received from a Global Navigation Satellite System (GNSS) satellite, and a method for calculating the position information from a relative position of a feature and map information around the subject vehicle which have been obtained by, for example, the LiDAR.

The vehicle sensor 130 obtains information on states of the subject vehicle such as a speed, an acceleration, an orientation, and an angular velocity of the subject vehicle. The vehicle sensor 130 includes, for example, a steering angle sensor, a steering torque sensor, a yaw rate sensor, a speed sensor, and an acceleration sensor.

The EPS controller 311, the powertrain controller 312, and the brake controller 313 are controllers that control an EPS motor 5, a powertrain unit 6, and brake units 7 for attaining target values of the steering angle, the driving force, and the braking force of the subject vehicle, respectively.

The vehicle control unit 200 is a unit that controls operations of the vehicle. The vehicle control unit 200 computes the target values of the steering angle, the driving force, and the braking force of the subject vehicle, and enters the target values into the EPS controller 311, the powertrain controller 312, and the brake controller 313. The vehicle control unit 200 is an integrated circuit such as a microprocessor, and includes a memory in which various programs are stored such as a read only memory (ROM) or a random access memory (RAM), and a processor that executes the programs such as a central processing unit (CPU). The processor executes a program, so that functions of the vehicle control unit 200 are performed. Specific examples of the vehicle control unit 200 include an advanced driver-assistance systems Electronic Control Unit (ADAS-ECU). The details of the vehicle control unit 200 will be described later.

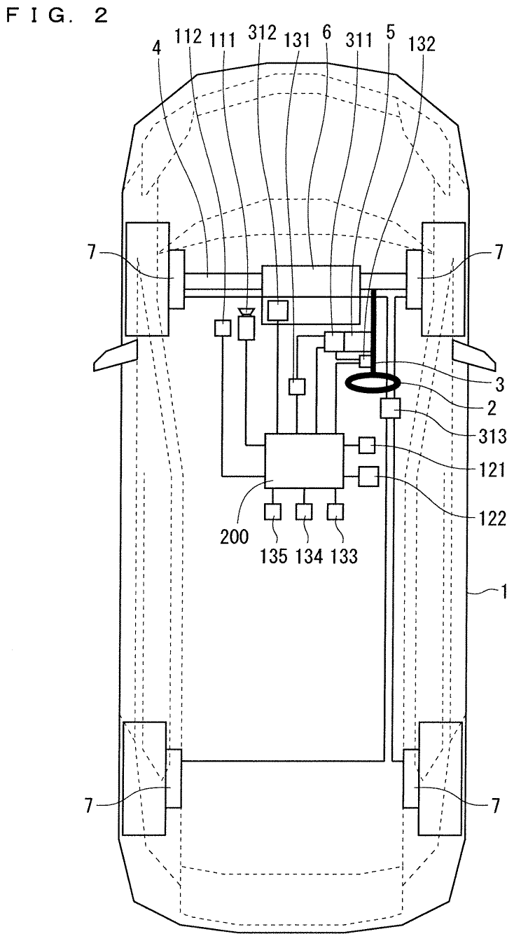

FIG. 2 illustrates a schematic structure of the subject vehicle 1 that is a vehicle on which the vehicle control unit 200 is mounted. The subject vehicle 1 includes a steering wheel 2, a steering axle 3, a steering unit 4, an EPS motor 5, a powertrain unit 6, brake units 7, a forward camera 111, a radar sensor 112, a GNSS sensor 121, a navigation device 122, a steering angle sensor 131, a steering torque sensor 132, a yaw rate sensor 133, a speed sensor 134, an acceleration sensor 135, the vehicle control unit 200 illustrated in FIG. 1, the EPS controller 311, the powertrain controller 312, and the brake controller 313.

The steering wheel 2 is also called a hand wheel for the driver to operate the subject vehicle 1. The steering wheel 2 is joined to the steering axle 3 communicating to the steering unit 4. The steering unit 4 rotatably supports the front wheels as the steering tires, and is supported by a car frame so that the steering unit 4 can be steered. Thus, a steering torque generated by the driver through operating the steering wheel 2 causes the steering axle 3 to rotate. The steering unit 4 horizontally steers the front wheels according to the rotation of the steering axle 3. Consequently, the driver can manipulate an amount of lateral movement of the subject vehicle 1 when the subject vehicle 1 moves forward or backward.

The steering axle 3 may be rotated by the EPS motor 5. The EPS controller 311 controls the current that flows through the EPS motor 5, so that the front wheels can be steered independent of the operation of the steering wheel 2 by the driver.

The vehicle control unit 200 is connected to the forward camera 111, the radar sensor 112, the GNSS sensor 121, the navigation device 122, the steering angle sensor 131, the steering torque sensor 132, the yaw rate sensor 133, the speed sensor 134, the acceleration sensor 135, the EPS controller 311, the powertrain controller 312, and the brake controller 313.

The forward camera 111 is disposed in a position where dividing lines ahead of the vehicle can be detected as an image, and detects a forward environment of the subject vehicle such as the lane information or a position of an obstacle, based on the image information. Although FIG. 2 illustrates only the forward camera that detects the forward environment, the subject vehicle 1 may include a camera that detects a rear or lateral environment. The radar sensor 112 irradiates an obstacle with radar beam, and detects the reflected wave to output a relative distance and a relative speed of the obstacle with respect to the subject vehicle 1. The radar sensor 112 may be a known device such as a millimeter wave radar, a LiDAR, a laser range finder, or an ultrasonic radar. The external sensor 110 illustrated in FIG. 1 includes the forward camera 111 and the radar sensor 112. The forward camera 111 may be used as a means for detecting a relative distance and a relative speed of an obstacle.

The GNSS sensor 121 receives radio waves from a positioning satellite via an antenna, and outputs an absolute position and an absolute orientation of the subject vehicle 1 through positioning computation. The navigation device 122 has a function of computing the optimal traveling route to a destination set by the driver. Map data including road information on roads included in a road network is stored in the navigation device 122. The road information is map node data for representing road alignments. Each map node data includes information on, for example, an absolute position (a latitude, a longitude, an altitude) of a node, a lane width, a road curvature, an angle of cant, and an angle of dip. The locator 120 illustrated in FIG. 1 includes the GNSS sensor 121 and the navigation device 122.

The steering angle sensor 131 detects a steering angle of the steering wheel 2. The steering torque sensor 132 detects a steering torque of the steering axle 3. The yaw rate sensor 133 detects a yaw rate of the subject vehicle 1. The speed sensor 134 detects a speed of the subject vehicle 1. The acceleration sensor 135 detects an acceleration of the subject vehicle 1. The vehicle sensor 130 illustrated in FIG. 1 includes the steering angle sensor 131, the steering torque sensor 132, the yaw rate sensor 133, the speed sensor 134, and the acceleration sensor 135.

Although FIG. 2 illustrates, as the example of the subject vehicle 1, a vehicle that applies only an engine as the driving power source, the subject vehicle 1 may be an electrical car that applies an electric motor as the driving power source, or a hybrid car that applies both of the engine and the electric motor as the driving power source.

Referring back to FIG. 1, the details of the vehicle control unit 200 according to Embodiment 1 will be described. As illustrated in FIG. 1, the vehicle control unit 200 includes a set-of-coordinates generator 210 and a vehicle control device 201.

The set-of-coordinates generator 210 generates point-series information including a plurality of sets of coordinates indicating a plurality of positions through which the subject vehicle needs to travel, based on at least one of road dividing line information and a position information history of the preceding vehicle that are obtained from the external sensor 110, and the map information obtained from the locator 120. For example, when the vehicle control unit 200 performs lane keeping control on the subject vehicle, the set-of-coordinates generator 210 generates the point-series information at least based on the road dividing line information. When the vehicle control unit 200 makes the subject vehicle follow the preceding vehicle, the set-of-coordinates generator 210 generates the point-series information at least based on the position information history of the preceding vehicle. When the vehicle control unit 200 makes the subject vehicle travel along a route to a destination, the set-of-coordinates generator 210 generates sets of coordinates at least based on the map information. The set-of-coordinates generator 210 may generate the point-series information from combinations of two or more of the road dividing line information, the position information history, and the map information.

For simplifying the following description, a set of coordinates generated by the set-of-coordinates generator 210 and indicating a position through which the subject vehicle needs to travel will be simply referred to as “a set of coordinates”, and point-series information including a plurality of sets of coordinates generated by the set-of-coordinates generator 210 will be simply referred to as “point-series information”.

The vehicle control device 201 includes a reference route generator 220, a planned traveling distance computing unit 230, a target value computing unit 240, and a vehicle controller 250.

The reference route generator 220 calculates a route length from a preset reference point to each set of coordinates (chronological distances between the sets of coordinates), based on the point-series information generated by the set-of-coordinates generator 210, and performs polynomial approximation that approximates the plurality of sets of coordinates by polynomials each of which is a function of the route length from the reference point to generate a reference route to be a route for reference.

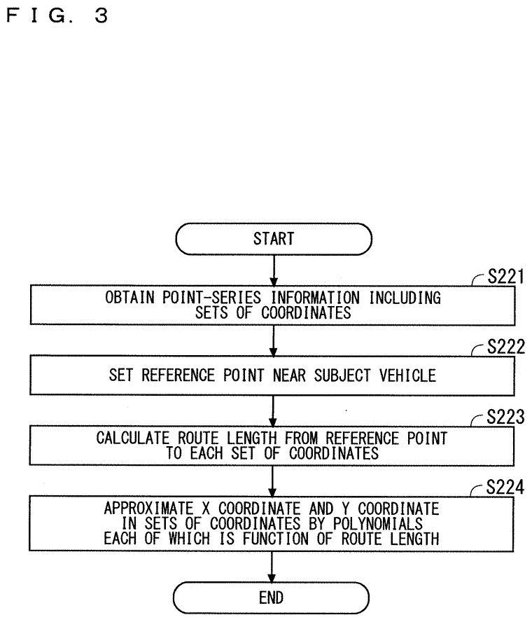

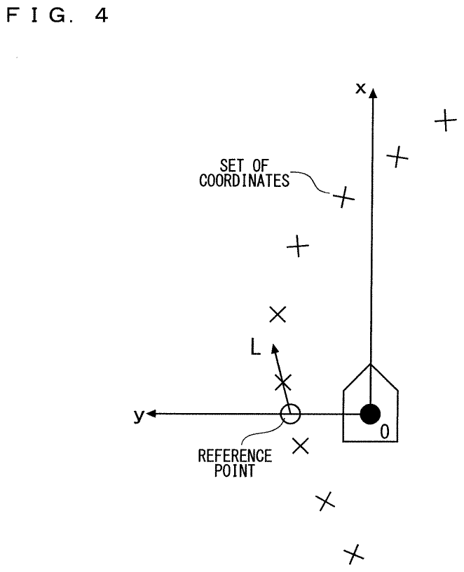

Operations of the reference route generator 220 will be described with reference to the flowchart in FIG. 3. First, the reference route generator 220 obtains the point-series information including a plurality of sets of coordinates generated by the set-of-coordinates generator 210 (Step S221). Each of the sets of coordinates is represented by a subject-vehicle coordinate system with respect to a position of the subject vehicle according to Embodiment 1. As illustrated in FIG. 4, the subject-vehicle coordinate system is defined as a coordinate system using a direction straight ahead of the subject vehicle as an x coordinate and a direction to the right or left of the subject vehicle as a y coordinate with respect to the subject-vehicle position as the origin. In each set of coordinates (x, y), the x coordinate will be referred to as a “longitudinal position”, and the y coordinate will be referred to as a “lateral position”.

Next, the reference route generator 220 sets, near the subject-vehicle position, a reference point for reference for calculating a route length (Step S222). The position of the reference point is set on a set of coordinates, between sets of coordinates, or on an extension of a line or a curve connecting the sets of coordinates. FIG. 4 illustrates an example reference point. In FIG. 4, the reference point is set at an intersection point between a line when x=0 and a line connecting a set of coordinates including the smallest x coordinate satisfying x≥0 to a set of coordinates including the largest x coordinate satisfying x<0. A method for setting a reference point is not limited to this example but may be any. Examples of the reference point may include an intersection point between x=0 and a curve obtained by approximating a plurality of sets of coordinates by polynomial functions or spline functions, and an intersection point between a curve obtained by approximating a plurality of sets of coordinates by polynomial functions or spline functions and a normal from a subject-vehicle position to the curve.

Next, the reference route generator 220 determines a route length L from the reference point set in Step S222 to each set of coordinates (Step S223). According to Embodiment 1, a linear distance from the reference point to a set of coordinates is defined as the route length L. The definition of the route length L is not limited to this. For example, a distance obtained by line integrating the curve obtained by approximating a plurality of sets of coordinates by polynomial functions or spline functions may be defined as the route length L. Furthermore, when a set of coordinates is obtained as three-dimensional coordinates including an altitude (a height above the sea level), the route length L may be defined as a three-dimensional distance from the reference point to the set of coordinates. Here, the planned traveling distance computing unit 230 calculates a planned traveling distance as a three-dimensional distance.

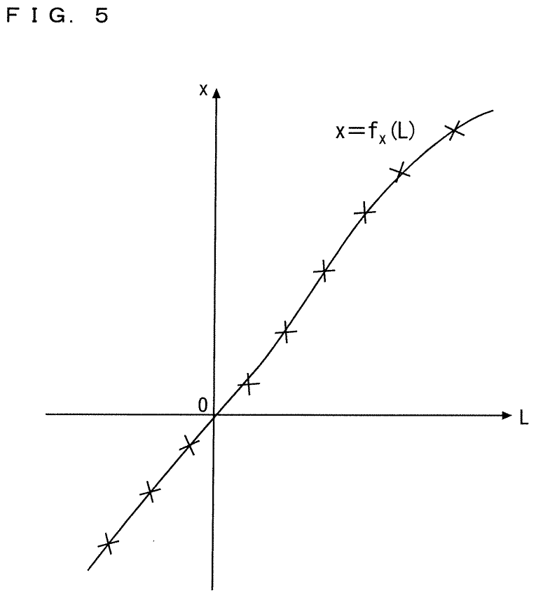

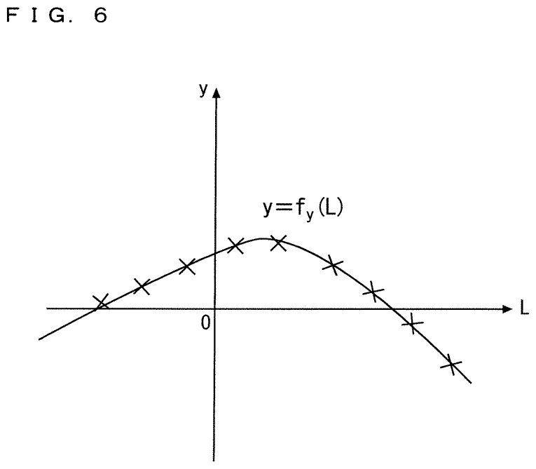

Then, the reference route generator 220 performs polynomial approximation that approximates an x coordinate (a subject-vehicle longitudinal position) and a y coordinate (a subject-vehicle lateral position) in the sets of coordinates by m-th degree polynomials (M is an integer greater than or equal to 1) each of which is a function of the route length L (Step S224). For example, the plurality of sets of coordinates in FIG. 4 have a relationship with the route length L and the subject-vehicle longitudinal position x as illustrated in FIG. 5, and have a relationship with the route length L and the subject-vehicle lateral position y as illustrated in FIG. 6. The reference route generator 220 determines a polynomial fₓ (L) by which the relationship with the route length L and the subject-vehicle longitudinal position x has been approximated, and a polynomial f_{y} (L) by which the relationship with the route length L and the subject-vehicle lateral position y has been approximated.

In Embodiment 1, the reference route generator 220 approximates, by cubic polynomials, the subject-vehicle longitudinal position x and the subject-vehicle lateral position y. Here, the subject-vehicle longitudinal position x and the subject-vehicle lateral position y are expressed by Equation 101 and Equation 102 below, respectively. The reference route generator 220 calculates a value of each coefficient included in Equation 101 and Equation 102.

[Math 1]

x=fₓ(L)=C₃ₓL³+C₂ₓL²+C₁ₓL+C₀ₓ (Equation 101)

[Math 2]

y=f_{y}(L)=C_{3y}L³+C_{2y}L²+C_{1y}L+C_{0y} (Equation 102)

Although the point-series information obtained by the reference route generator 220 includes only the x coordinate (subject-vehicle longitudinal position) and the y coordinate (subject-vehicle lateral position) of each set of coordinates in Embodiment 1, the point-series information may include information other than these, for example, a speed and a yaw rate at which the subject vehicle needs to travel at the set of coordinates, a road curvature at the set of coordinates, and an azimuth angle of the road. When the point-series information includes such information, the reference route generator 220 may approximate the information by a polynomial. In other words, the reference route generator 220 may approximate any information by a polynomial, according to the details of the point-series information obtained from the set-of-coordinates generator 210, and a parameter for which the vehicle controller 250 calculates a target value.

The planned traveling distance computing unit 230 calculates a planned traveling distance that is a distance that the subject vehicle needs to travel in a predefined unit time, based on one or both of the speed and a target speed of the subject vehicle. Assuming that V_{tg} denotes the speed or the target speed of the subject vehicle and Δt denotes the unit time all of which are used for computing a planned traveling distance, the planned traveling distance L_{tg} of the subject vehicle in a unit time is expressed as L_{tg}=V_{tg}Δt.

The target value computing unit 240 computes a target value of each parameter to be used for controlling an actuator of the subject vehicle, based on the reference route expressed by the polynomial generated by the reference route generator 220, and the planned traveling distance of the subject vehicle calculated by the planned traveling distance computing unit 230. Specifically, the planned traveling distance computing unit 230 calculates a target position that is a target value of a position of the subject vehicle after the unit time, and a target azimuth angle that is a target value of an azimuth angle of the subject vehicle after the unit time. Furthermore, the target value computing unit 240 calculates a target steering angle that is a target value of a steering angle of the subject vehicle after the unit time, from the target position and the target azimuth angle of the subject vehicle, and a road curvature at the target position.

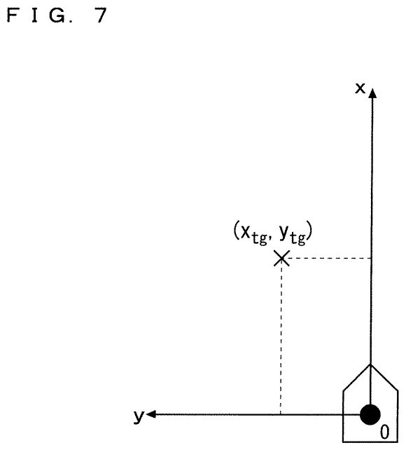

As illustrated in FIG. 7, assuming that x_{tg} denotes an x coordinate of the target position of the subject vehicle and y_{tg} denotes a y coordinate of the same position, each of x_{tg} and y_{tg} is expressed as below.

[Math 3]

x_{tg}fₓ(L_{tg})=C₃ₓL_{tg}³+C₂ₓL_{tg}²+C₁ₓL_{tg}+C₀ₓ (Equation 103)

[Math 4]

y_{tg}=f_{y}(L_{tg})=C_{3y}L_{tg}³+C_{2y}L_{tg}²+C_{1y}L_{tg}+C_{0y} (Equation 104)

Here, each of the target azimuth angle θ_{tg} and the road curvature κ_{tg} of the subject vehicle can be calculated using a cubic polynomial with x and y as follows.

$$\begin{matrix}[ Math 5 ] & \\ {{θ}_{tg} = atan ( \frac{dx}{dy} ) \vert}_{{L}_{tg}} & ( Equation 105 )\end{matrix}$$

$$\begin{matrix}[ Math 6 ] & \\ {{κ}_{tg} = ( \frac{{d}^{2} x}{{dy}^{2}} ) / {( 1 + {( \frac{dx}{dy} )}^{2} )}^{\frac{3}{2}} \vert}_{{L}_{tg}} & ( Equation 106 )\end{matrix}$$

When the point-series information includes information on the azimuth angle at which the subject vehicle needs to travel at each set of coordinates and on the road curvature at each of the sets of coordinates, each of the target azimuth angle θ_{tg} and the road curvature κ_{tg} of the subject vehicle may be calculated using a cubic polynomial as follows.

[Math 7]

θ_{tg}=f_{θ}(L_{tg})=C_{3θ}L_{tg}³+C_{2θ}L_{tg}²+C_{1θ}L_{tg}+C_{0θ} (Equation 107)

[Math 8]

κ_{tg}=f_{κ}(L_{tg})=C_{3κ}L_{tg}³+C_{2κ}L_{tg}²+C_{1κ}L_{tg}+C_{0κ} (Equation 108)

The vehicle controller 250 calculates control target values for the actuator, specifically, a target steering angle, a target driving force, and a target braking force so that an error between the position of the subject vehicle at the current time which is obtained by the vehicle sensor 130 and the target position of the subject vehicle which is calculated by the target value computing unit 240 and an error between the azimuth angle of the subject vehicle at the current time which is obtained by the vehicle sensor 130 and the target azimuth angle of the subject vehicle which is calculated by the target value computing unit 240 are reduced and so that the steering angle and the speed of the subject vehicle become values corresponding to the target curvature of the subject vehicle. Then, the vehicle control unit 250 transmits the target steering angle to the EPS controller 311, transmits the target driving force to the powertrain controller 312, and transmits the target braking force to the brake controller 313.

The EPS controller 311 controls the EPS motor 5 so that the EPS motor 5 attains the target steering angle received from the vehicle control unit 250. The powertrain controller 312 controls the powertrain unit 6 so that the powertrain unit 6 attains the target driving force received from the vehicle control unit 250. The brake controller 313 controls the brake units 7 so that the brake units 7 attain the target braking force received from the vehicle control unit 250. Consequently, the subject vehicle is controlled so that the subject vehicle travels along the reference route expressed by Equations 101 and 102.

While the driver controls the steering of the subject vehicle, the EPS controller 311 controls the EPS motor 5 based on a steering torque of the steering wheel 2. While the driver controls the speed of the subject vehicle, the powertrain controller 312 controls the powertrain unit 6 based on a depression amount of an accelerator pedal, and the brake controller 313 controls the brake units 7 based on a depression amount of a brake pedal.

Although the target value computing unit 240 calculates target values of the position and the azimuth angle of the subject vehicle, and the curvature of the road on which the subject vehicle travels in the description above, for example, when the point-series information includes information on the yaw rate at which the subject vehicle needs to travel at each set of coordinates, the reference route generator 220 may approximate the yaw rate at which the subject vehicle needs to travel at each set of coordinates by a polynomial that is a function of a route length from the reference point, and the target value computing unit 240 may calculate a target yaw rate that is a target value of the yaw rate of the subject vehicle after the unit time, from the polynomial and the planned traveling distance. Here, the vehicle controller 250 controls the actuator so that an error between the target yaw rate and the yaw rate of the subject vehicle obtained by the vehicle sensor 130 after the unit time is reduced.

As described above, the vehicle control unit 200 according to Embodiment 1 includes: the set-of-coordinates generator 210 that generates point-series information including a plurality of sets of coordinates representing a plurality of positions through which the subject vehicle needs to travel; and the vehicle control device 201 that performs polynomial approximation of the plurality of sets of coordinates included in the point-series information to calculate a reference route, and calculates a target steering angle, a target driving force, and a target braking force for making the subject vehicle travel along the reference route. Since the vehicle control device 201 approximates the plurality of sets of coordinates by polynomials each of which is a function of a route length from the reference point to calculate a reference route, even when the subject vehicle is steered at a right angle or makes a U-turn, the vehicle control device 201 can precisely express the reference route through which the subject vehicle needs to travel. This improves the route following performance in the automatic control for the subject vehicle.

When a vehicle moves backward, the planned traveling distance computing unit 230 sets the speed or the target speed (V_{tg}) of the subject vehicle which is used for calculating the planned traveling distance of the subject vehicle to a negative value. This enables the target value computing unit 240 to calculate a target position when the vehicle moves backward. Thus, Embodiment 1 is applicable not only when the subject vehicle moves forward but also when the subject vehicle moves backward.

Furthermore, assuming a forward gaze time as the unit time (Δt) to be used by the planned traveling distance computing unit 230 for calculating the planned traveling distance, the subject vehicle can be controlled so that the subject vehicle travels toward a forward gaze point, and can travel without making the passenger of the subject vehicle feel uncomfortable. Here, the forward gaze point is a location at which the driver is assumed to gaze in manually driving the subject vehicle. The forward gaze time is defined as a time required for the subject vehicle to reach the forward gaze point.

Although Embodiment 1 describes a configuration of connecting all of the EPS controller 311, the powertrain controller 312, and the brake controller 313 to the vehicle control unit 200, for example, the powertrain controller 312 and the brake controller 313 need not be connected to the vehicle control unit 200 when the vehicle control unit 200 does not control acceleration and deceleration of the subject vehicle.

As described above, the vehicle control unit 200 is an integrated circuit such as a microprocessor, and includes an A/D conversion circuit, a D/A conversion circuit, a processor such as a central processing unit (CPU), and a memory such as a read only memory (ROM) or a random access memory (RAM). The processor of the vehicle control unit 200 processes information received from the external sensor 110, the locator 120, and the vehicle sensor 130, according to a program stored in the ROM to perform functions of the set-of-coordinates generator 210, the reference route generator 220, the planned traveling distance computing unit 230, the target value computing unit 240, and the vehicle controller 250 and calculate a target steering angle, a target driving force, and a target braking force of the subject vehicle.

In other words, the vehicle control unit 200 includes a memory in which a program is stored. When the program is executed by a processor, the processor consequently performs processes of: obtaining point-series information including information on a plurality of sets of coordinates through which a subject vehicle needs to travel, and approximating, by polynomials, a longitudinal position and a lateral position of the subject vehicle based on the plurality of sets of coordinates to generate a reference route represented by the polynomials, each of the polynomials being a function of a route length from a preset reference point; calculating a planned traveling distance that is a distance that the subject vehicle needs to travel in a unit time of a predefined length; calculating a target position that is a target value of a position of the subject vehicle after the unit time, based on the polynomial of the longitudinal position of the subject vehicle, the polynomial of the lateral position of the subject vehicle, and the planned traveling distance; and controlling an actuator of the subject vehicle so that an error between the position of the subject vehicle after the unit time and the target position is reduced. Put it differently, this program causes a computer to execute procedures or methods of operations of the constituent elements of the vehicle control unit 200.

### Embodiment 2

Although the planned traveling distance computing unit 230 calculates only one planned traveling distance (L_{tg}) of the subject vehicle in a unit time in Embodiment 1, the planned traveling distance computing unit 230 calculates a plurality of planned traveling distances corresponding to a plurality of unit times that are different in length in Embodiment 2. Since the basic configuration and operations of the vehicle control unit 200 according to Embodiment 2 are identical to those according to Embodiment 1, the overlap with the description of Embodiment 1 will be omitted.

Here, an example where the planned traveling distance computing unit 230 calculates two planned traveling distances will be described. In other words, the planned traveling distance computing unit 230 calculates a first planned traveling distance that is a distance that the subject vehicle needs to travel in a predefined first unit time and a second planned traveling distance that is a distance that the subject vehicle needs to travel in a predefined second unit time, based on a speed or a target speed of the subject vehicle. Assuming that V_{tg} denotes the speed or the target speed of the subject vehicle, Δt₁ denotes the first unit time, and Δt₂ denotes the second unit time all of which are used for computing the planned traveling distances, the first planned traveling distance L_{tg1} and the second planned traveling distance L_{tg2} are expressed as L_{tg1}=V_{tg}Δt₁ and L_{tg2}=V_{tg}Δt₂, respectively.

The target value computing unit 240 computes a target value for controlling the actuator of the subject vehicle, based on the reference route expressed by the polynomial generated by the reference route generator 220, and the first planned traveling distance and the second planned traveling distance of the subject vehicle which have been calculated by the planned traveling distance computing unit 230. Here, the target value computing unit 240 selects one of the first planned traveling distance and the second planned traveling distance for each parameter for which a target value is calculated, and uses the selected planned traveling distance.

Assuming that the planned traveling distance computing unit 230 calculates the y coordinate (target lateral position) y_{tg} and the target azimuth angle θ_{tg} of the target position of the subject vehicle using the first planned traveling distance L_{tg1} and calculates the road curvature κ_{tg} using the second planned traveling distance L_{tg2}, the target lateral position y_{tg}, the target azimuth angle θ_{tg}, and the road curvature κ_{tg} are calculated as follows.

$$\begin{matrix}[ Math 9 ] & \\ {y}_{tg} = {f}_{y} ( {L}_{tg 1} ) = {C}_{3 y} {L}_{tg 1}^{3} + {C}_{2 y} {L}_{tg 1}^{2} + {C}_{1 y} {L}_{tg 1} + {C}_{0 y} & ( Equation 201 )\end{matrix}$$

$$\begin{matrix}[ Math 10 ] & \\ {{θ}_{tg} = atan ( \frac{dx}{dy} ) \vert}_{{L}_{tg 1}} & ( Equation 202 )\end{matrix}$$

$$\begin{matrix}[ Math 11 ] & \\ {{κ}_{tg} = ( \frac{{d}^{2} x}{{dy}^{2}} ) / {( 1 + {( \frac{dx}{dy} )}^{2} )}^{\frac{3}{2}} \vert}_{{L}_{tg 2}} & ( Equation 203 )\end{matrix}$$

The vehicle controller 250 calculates control target values for the actuator, specifically, a target steering angle, a target driving force, and a target braking force so that an error between the position of the subject vehicle at the current time which is obtained by the vehicle sensor 130 and the target position of the subject vehicle which is calculated by the target value computing unit 240 and an error between the azimuth angle of the subject vehicle at the current time which is obtained by the vehicle sensor 130 and the target azimuth angle of the subject vehicle which is calculated by the target value computing unit 240 are reduced and so that the steering angle and the speed of the subject vehicle become values corresponding to the target curvature of the subject vehicle. Then, the vehicle control unit 250 transmits the target steering angle to the EPS controller 311, transmits the target driving force to the powertrain controller 312, and transmits the target braking force to the brake controller 313.

For example, assuming a forward gaze time as the first unit timeΔt₁, the lateral position and the azimuth angle of the subject vehicle are controlled so that the subject vehicle travels toward a forward gaze point. Assuming that the second unit time Δt₂ is equal to 0, the steering angle of the subject vehicle is controlled according to a road curvature at the current position of the subject vehicle.

Since the use of a plurality of planned traveling distances of the subject vehicle according to Embodiment 2 enables setting of a target value at a different position for each parameter, the route following performance and the stability can be more highly controlled. Although the number of planned traveling distances is two in Embodiment 2, the number of planned traveling distances may be three or more. The vehicle controller 250 can increase the number of planned traveling distances up to the number of parameters for which target values are calculated at the maximum.

### Embodiment 3

In Embodiment 3, the planned traveling distance computing unit 230 calculates the planned traveling distance L_{tg} of the subject vehicle for each unit time Δt (sec) from the current time to the time after N*Δt (sec). In other words, the planned traveling distance computing unit 230 calculates a plurality of planned traveling distances L_{tg} corresponding to a plurality of times from the current time for each unit time Δt (sec). Assuming that V_{tg} denotes the speed or the target speed of the subject vehicle which is used for computing the planned traveling distances, each of the planned traveling distances L_{tg} corresponds to a vector quantity expressed by L_{tg}=V_{tg}Tᵢ (i=0, . . . , N).

The target computing unit 240 computes a target value for controlling the actuator of the subject vehicle, based on the reference route expressed by the polynomial generated by the reference route generator 220, and the planned traveling distances of the subject vehicle calculated by the planned traveling distance computing unit 230. Since the planned traveling distance L_{tg} corresponds to the vector quantity, the target value for controlling the actuator of the subject vehicle is also computed as a vector quantity. The target lateral position y_{tg}, the target azimuth angle θ_{tg}, and the target speed V_{tg} of the subject vehicle are calculated as follows.

[Math 12]

y_{tg}=f_{y}(L_{tg})=C_{3y}L³_{tg}+C_{2y}L_{tg}²+C_{1y}L_{tg}+C_{0y} (Equation 301)

[Math 13]

θ_{tg}=f_{θ}(L_{tg})=C_{3θ}L_{tg}³+C_{2θ}L_{tg}²+C_{1θ}L_{tg}+C_{0θ} (Equation 302)

[Math 14]

V_{tg}=f_{V}(L_{tg})=C_{3V}L_{tg}³+C_{2V}L_{tg}²+C_{1V}L_{tg}+C_{0θ} (Equation 303)

The vehicle controller 250 predicts a behavior of the subject vehicle from the current time 0 up to the time after N*Δt at intervals of the unit time Δt, using a dynamic vehicle model that is a motion model mathematically expressing vehicle dynamics so that the position, the azimuth angle, and the speed of the subject vehicle follow target values at a plurality of locations calculated by the target value computing unit 240 (target values at a plurality of times). Then, the vehicle controller 250 solves, at regular intervals, an optimization problem for finding a control input u for minimizing an evaluation function that represents a desired operation of the subject vehicle to compute the optimal target amount of steering, or the optimal target amount of steering and the optimal target acceleration. Here, a vehicle state quantity is predicted at the point N.

According to Embodiment 3, the vehicle controller 250 solves the optimization problems with constraints as indicated below at regular intervals.

[Math 15]

minᵤJ (Equation 304)

[Math 16]

s.t. \dot{x}=f(x, u)

x₀=x(0)

g(x, u)≤0 (Equation 305)

Here, J denotes an evaluation function, x denotes a vehicle state quantity, u denotes a control input, f denotes a vector-valued function on the dynamic vehicle model, x₀ denotes an initial value, and g denotes a vector-valued function on the constraints. Although the optimization problem is handled as a minimization problem according to Embodiment 3, the optimization problem can be handled as a maximization problem by reversing the sign of the evaluation function.

The vehicle state quantity x and the control input u are defined as follows.

[Math 17]

x=[X_{c}, Y_{c}, θ, β, γ, δ, V, α]^{T} (Equation 306)

[Math 18]

u=[ω, j]^{T} (Equation 307)

Here, β denotes an angle of sideslip, γ denotes a yaw rate, δ denotes a steering angle, ω denotes a steering angle velocity, α denotes an acceleration, and j denotes a jerk. There is no need to make the control input u coincide with a controlled variable of each of the actuator controllers (the EPS controller 311, the powertrain controller 312, and the brake controller 313). Thus, the vehicle state quantity x and the control input u can be set independent of the controlled variables of the actuator controllers. Substituting the steering angle velocity for the steering angle as the control input can easily limit the magnitude of variations in the steering angle, depending on the evaluation function or settings of the constraints. Thus, the riding comfort of the vehicle will be improved. Similarly, substituting the jerk for the acceleration as the control input can easily limit the magnitude of variations in the acceleration, depending on the evaluation function or the settings of the constraints. Thus, the riding comfort of the vehicle will be improved.

The following two-wheel model will be used as the dynamic vehicle model f.

$$\begin{matrix}[ Math 19 ] & \\ \dot{x} = f ( x , u ) = [ \begin{matrix}\begin{matrix}\begin{matrix}\begin{matrix}\begin{matrix}\begin{matrix}\begin{matrix}V cos ( θ + β ) \\ V sin ( θ + β )\end{matrix} \\ γ\end{matrix} \\ - ( 1 + \frac{2 ( {C}_{f} {l}_{f} - {C}_{r} {l}_{r} )}{{MV}^{2}} ) γ - \frac{2}{MV} ( {C}_{f} + {C}_{r} ) β + \frac{2 {C}_{f}}{MV} δ\end{matrix} \\ - \frac{2}{IV} ( {C}_{f} {l}_{f}^{2} + {C}_{r} {l}_{r}^{2} ) γ - \frac{2}{I} ( {C}_{f} {l}_{f} - {C}_{r} {l}_{r} ) β + \frac{2}{I} {C}_{f} {l}_{f} δ\end{matrix} \\ ω\end{matrix} \\ α\end{matrix} \\ j\end{matrix} ] & ( Equation 308 )\end{matrix}$$

Here, x=[X_{c}, Y_{c}, θ, β, γ, V]^{T} and u=[δ, α]^{T} may be satisfied for simplifying the model.

The following Equation will be used as the evaluation function J according to Embodiment 3.

[Math 20]

J=(h_{N}(x_{N})−r_{N})^{T}W_{N}(h_{N}(x_{N})−r_{N})+Σₖ₌₀^{N-1}(h(xₖ, uₖ)−rₖ)^{T}W(h(xₖ, uₖ)−rₖ) (Equation 309)

Here, xₖ denotes a vehicle state quantity at a predicted point k (k=0, . . . N), whereas uₖ denotes a control input at the predicted point k (k=0, . . . , N−1). h denotes a vector-valued function on an evaluation item, h_{N} denotes a vector-valued function on the evaluation item at the end (a predicted point N), and rₖ denotes a target value at the predicted point k (k=0, . . . N). Each of W and W_{N} denotes a weighted matrix that is a diagonal matrix having weights to the respective evaluation items as diagonal components, and can be appropriately changed as a parameter.

The steering is controlled so that the vehicle travels along the center of a lane with a small control input. The vector-valued functions h and h_{N} on an evaluation item will be set as follows so that the speed follows the target speed.

[Math 21]

h=[e_{Y,k}, e_{θ,k}, wₖ, e_{V,k}, jₖ]^{T} (Equation 310)

[Math 22]

h_{N}−[e_{Y,N}, e_{θ,N}, e_{V,N}]^{T} (Equation 311)

Here, e_{Y,k}, e_{θ,k}, and e_{V,k} denote following errors (differences between predicted values and target values) to the target route, the target azimuth angle, and the target speed, respectively, at the predicted point k (k=0, . . . , N). The route following error e_{Y, k} is expressed by e_{Y,k}=Y_{c,k}−y_{tg,k}. The angle following error e_{θ,k} is expressed by e_{θ,k}=θₖ−θ_{tg,k}. The speed following error e_{V,k} is expressed by e_{V,k}=Vₖ−V_{tg,k}. Then, the target values rₖ and r_{N} are set as follows so that the route following error e_{Y,k}, the angle following error e_{θ,k}, the steering speed ωₖ, the speed following error e_{V,k}, and the jerk jₖ are reduced.

[Math 23]

rₖ=[0,0,0,0,0]^{T}(k=0, . . . , N−1) (Equation 312)

[Math 24]

r_{N=[0,0,0]}^{T} (Equation 313)

Although the evaluation items are set to evaluate a route following error, an angle following error, a steering speed, a speed following error, and a jerk according to Embodiment 3, for example, an acceleration and a yaw rate may be added to the evaluation items to improve the riding comfort of the vehicle.

Next, the vector-valued function g on constraints will be described. The function g is to set upper limit values and lower limit values (may be referred to as “upper and lower limit values”) of the vehicle state quantity x and the control input u in the optimization problem with constraints. The optimization will be performed under a condition of g(x, u)≤0.

Assuming upper limit values of the steering speed co and the jerk j as ^{_}ω and ^{_}j (>0) and lower limit values thereof as _ω and _j (<0), the function g is defined as follows to operate with a control input in a certain range according to Embodiment 3 (the symbol “_” represents an underscore attached to a subsequent character, and the symbol “^{_}” represents an overline attached to a subsequent character).

$$\begin{matrix}[ Math 25 ] & \\ g = [ \begin{matrix}ω - \overline{ω} \\ - ω + \underline{ω} \\ j - \overline{j} \\ - j + \underline{j}\end{matrix} ] & ( Equation 314 )\end{matrix}$$

Setting the upper and lower limit values of the steering speed ω and the jerk j enables implementation of the vehicle control while the riding comfort is maintained. The upper and lower limit values of, for example, an orientation, a yaw rate, and an acceleration may be set for maintaining the riding comfort. The upper and lower limit values of the speed may be set for observing the speed limit.

The vehicle controller 250 solves the aforementioned optimization problems with constraints to compute the target steering angle and the target acceleration of the subject vehicle, and transmits the target steering angle and the target acceleration to the EPS controller 311, the powertrain controller 312, and the brake controller 313.

Since the vehicle controller 250 can compute the target steering angle and the target acceleration each with a smaller cumulative total of errors to a plurality of target positions according to Embodiment 3, the route following performance of the subject vehicle will be improved. Furthermore, evaluating a yaw rate or an acceleration with an evaluation function produces an advantage of improving the riding comfort.

### Embodiment 4

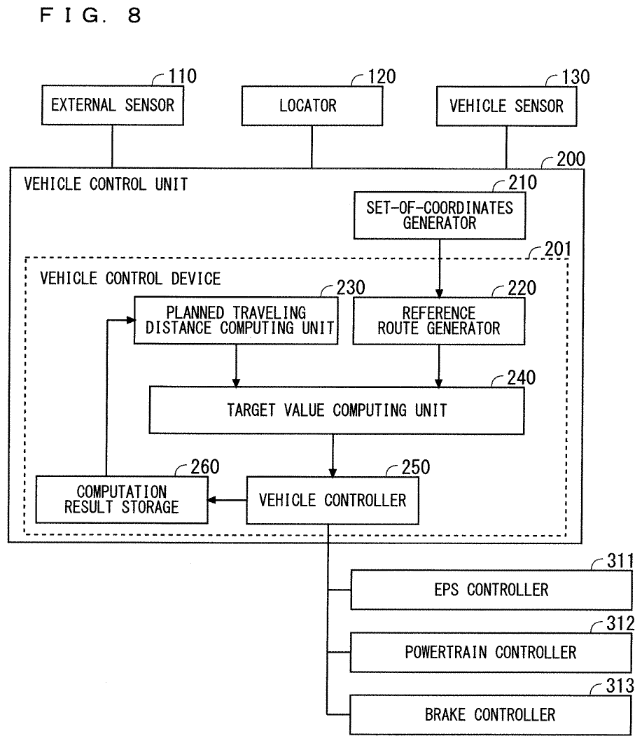

FIG. 8 is a block diagram illustrating a configuration of the vehicle control unit 200 according to Embodiment 4. The configuration of the vehicle control unit 200 according to Embodiment 4 is obtained by adding a computation result storage 260 to the vehicle control device 201 in the configuration of FIG. 1. A computation result of the vehicle controller 250 is stored in the computation result storage 260. Since the other configurations are identical to those in Embodiments 1 to 3, the overlap with the description of Embodiments 1 to 3 will be omitted.

A computation result of the vehicle controller 250 on the speed is stored in the computation result storage 260. Specifically, information on a predicted speed of the subject vehicle is stored in the computation result storage 260. The information has been calculated when errors between a position, an azimuth angle, and a steering angle of the subject vehicle after the unit time, and target values of these are determined. The information on the predicted speed to be stored in the computation result storage 260 may be a speed (Vₖ) at an arbitrary time, or time-series information on the speed (Vᵢ(i=1, . . . , N)).

The planned traveling distance computing unit 230 computes a planned traveling distance that is a distance that the subject vehicle needs to travel in the unit time Δt, using the information on the predicted speed which is stored in the computation result storage 260. With application of Embodiment 4 to Embodiment 3, the planned traveling distance computing unit 230 computes a planned traveling distance for each unit time Δt from the current time to the time after N*Δt, using the information on the speed which is stored in the computation result storage 260.

According to Embodiment 4, the planned traveling distance computing unit 230 computes a planned traveling distance, using the computation result of the vehicle controller 250 on the speed, that is, a computation result of the speed of the subject vehicle to be predicted in the future. This allows the vehicle controller 250 to generate a route through which a vehicle travels more easily, which will improve the riding comfort of the vehicle.

### Embodiment 5

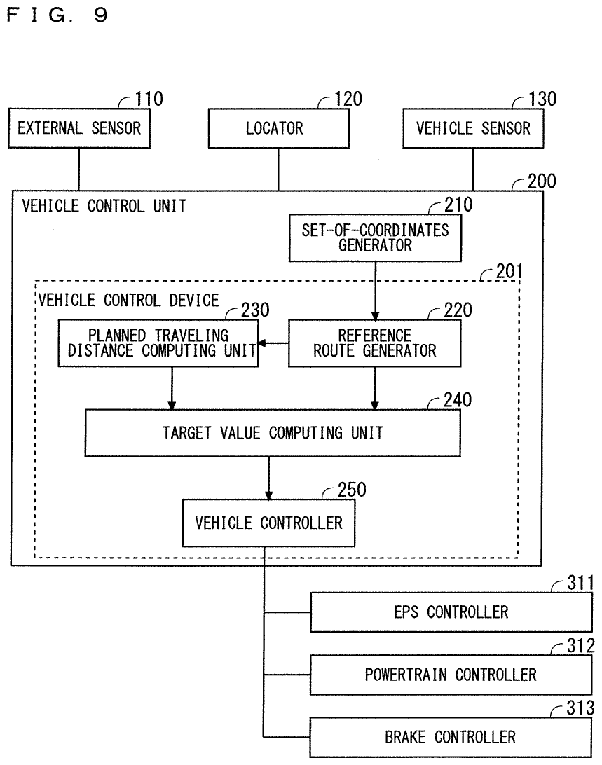

FIG. 9 is a block diagram illustrating a configuration of the vehicle control unit 200 according to Embodiment 4. The configuration of the vehicle control unit 200 according to Embodiment 4 is almost the same as that according to Embodiment 1 except that the reference route generator 220 feeds, to the planned traveling distance computing unit 230, a result obtained through polynomial approximation of the speed of the subject vehicle. The planned traveling distance computing unit 230 calculates the planned traveling distance that is a distance that the subject vehicle needs to travel in the unit time Δt, using the polynomial of the speed of the subject vehicle which has been obtained from the reference route generator 220. Since the other configurations are identical to those in Embodiments 1 to 3, the overlap with the description of Embodiments 1 to 3 will be omitted.

In Embodiment 5, the point-series information includes information on a speed at which the subject vehicle needs to travel at each set of coordinates. The reference route generator 220 further performs polynomial approximation that approximates the speed at which the subject vehicle needs to travel at each set of coordinates with a polynomial that is a function of a route length from the reference point. Here, the reference route generator 220 approximates, by a cubic polynomial, the speed at which the subject vehicle needs to travel. The speed V at which the subject vehicle needs to travel is represented by the following cubic polynomial.

[Math 26]

V=f_{V}(L)=C_{3V}L³+C_{2V}L²+C_{1V}L+C_{0θ} (Equation 501)

The planned traveling distance 230 solves simultaneous equations between the cubic polynomial of the speed V calculated by the reference route generator 220 and a relational expression L=VΔt on a distance L that the vehicle travels at the speed V for the unit time Δt to compute the planned traveling distance L_{tg} of the subject vehicle at the unit time Δt.

Since the distance that the vehicle travels for the unit time Δt at the speed calculated from a plurality of sets of coordinates obtained from the set-of-coordinates generator 210 is calculated as the planned traveling distance L_{tg} in Embodiment 5, the route following performance of the subject vehicle will be improved.

Embodiments can be freely combined or appropriately modified and omitted.

The description is in all aspects exemplifications, and numerous modifications and variations that have not yet been exemplified can be devised.

### EXPLANATION OF REFERENCE SIGNS

1 subject vehicle, 2 steering wheel, 3 steering axle, 4 steering unit, 5 EPS motor, 6 powertrain unit, 7 brake unit, 50 processing circuit, 51 processor, 52 memory, 110 external sensor, 111 forward camera, 112 radar sensor, 121 GNSS sensor, 122 navigation device, 131 steering angle sensor, 132 steering torque sensor,133 yaw rate sensor, 134 speed sensor, 135 acceleration sensor, 120 locator, 130 vehicle sensor, 200 vehicle control unit, 201 vehicle control device, 210 set-of-coordinates generator, 220 reference route generator, 230 planned traveling distance computing unit, 240 target value computing unit, 250 vehicle controller, 260 computation result storage, 311 EPS controller , 312 powertrain controller, 313 brake controller.

1. A vehicle control device, comprising:
a processor to execute a program; and
a memory to store the program which, when it is executed by the processor, causes the processor to perform processes comprising:
obtaining point-series information including information on a plurality of sets of coordinates through which a subject vehicle needs to travel, and approximating, by polynomials, a longitudinal position and a lateral position of the subject vehicle based on the plurality of sets of coordinates to generate a reference route represented by the polynomials, each of the polynomials being a function of a route length from a preset reference point;
calculating a planned traveling distance that is a distance that the subject vehicle needs to travel in a unit time of a predefined length;
calculate calculating a target position that is a target value of a position of the subject vehicle after the unit time, based on the polynomial of the longitudinal position of the subject vehicle, the polynomial of the lateral position of the subject vehicle, and the planned traveling distance; and
controlling an actuator of the subject vehicle so that an error between the position of the subject vehicle after the unit time and the target position is reduced,
wherein the point-series information includes information on a speed at which the subject vehicle needs to travel at each of the plurality of sets of coordinates,
the processor further approximates the speed at which the subject vehicle needs to travel at each of the plurality of sets of coordinates by a polynomial that is a function of the route length from the reference point, and
the processor calculates the planned traveling distance based on the polynomial of the speed at which the subject vehicle needs to travel.

2. The vehicle control device according to claim 1,
wherein the processor calculates a plurality of planned traveling distances corresponding to a plurality of times at intervals of the unit time from a current time, the plurality of planned traveling distances including the planned traveling distance,
the processor calculates a plurality of target positions corresponding to the plurality of times, based on the plurality of planned traveling distances, the plurality of target positions including the target position, and
the processor controls the actuator of the subject vehicle so that a cumulative total of errors between positions of the subject vehicle corresponding to the plurality of times and the plurality of target positions corresponding to the plurality of times is reduced, the positions of the subject vehicle being calculated using a motion model of the subject vehicle and including the position of the subject vehicle.

3. The vehicle control device according to claim 1,
wherein the processor calculates the planned traveling distance based on at least one of a speed and a target speed of the subject vehicle.

4. The vehicle control device according to claim 1, further comprising
storage in which information on a predicted speed of the subject vehicle is stored, the predicted speed being calculated when the processor determines the error between the position of the subject vehicle after the unit time and the target position,
wherein the processor calculates the planned traveling distance based on the information stored in the storage.

5. (canceled)

6. The vehicle control device according to claim 1,
wherein the point-series information includes information on an azimuth angle at which the subject vehicle needs to travel at each of the plurality of sets of coordinates,
the processor further approximates the azimuth angle at which the subject vehicle needs to travel at each of the plurality of sets of coordinates by a polynomial that is a function of the route length from the reference point,
the processor further calculates a target azimuth angle that is a target value of an azimuth angle of the subject vehicle after the unit time, based on the polynomial of the azimuth angle at which the subject vehicle needs to travel, and the planned traveling distance, and
the processor further controls the actuator of the subject vehicle so that an error between the azimuth angle of the subject vehicle after the unit time and the target azimuth angle is reduced.

7. The vehicle control device according to claim 1,
wherein the point-series information includes information on a road curvature at each of the plurality of sets of coordinates,
the processor further approximates the road curvature at each of the plurality of sets of coordinates by a polynomial that is a function of the route length from the reference point,
the processor further calculates a target steering angle that is a target value of a steering angle of the subject vehicle after the unit time, based on the polynomial of the road curvature and the planned traveling distance, and
the processor further controls the actuator of the subject vehicle so that an error between the steering angle of the subject vehicle after the unit time and the target steering angle is reduced.

8. The vehicle control device according to claim 1,
wherein the point-series information includes information on a yaw rate at which the subject vehicle needs to travel at each of the plurality of sets of coordinates,
the processor further approximates the yaw rate at which the subject vehicle needs to travel at each of the plurality of sets of coordinates by a polynomial that is a function of the route length from the reference point,
the processor further calculates a target yaw rate that is a target value of a yaw rate of the subject vehicle after the unit time, based on the polynomial of the yaw rate at which the subject vehicle needs to travel, and the planned traveling distance, and
the processor further controls the actuator of the subject vehicle so that an error between the yaw rate of the subject vehicle after the unit time and the target yaw rate is reduced.

9. The vehicle control device according to claim 1,
wherein the processor calculates a plurality of planned traveling distances corresponding to a plurality of unit times that are different in length, the plurality of unit times including the unit time, and
the processor selects one of the plurality of planned traveling distances according to a parameter for which a target value is calculated, and uses the selected one of the plurality of planned traveling distances.

10. The vehicle control device according to claim 1,
wherein each of the plurality of sets of coordinates is a set of three-dimensional coordinates including information on an altitude, and
the route length and the planned traveling distance are three-dimensional distances.

11. A vehicle control device, comprising:
a processor to execute a program; and
a memory to store the program which, when it is executed by the processor, causes the processor to perform processes comprising:
obtaining point-series information including information on a plurality of sets of coordinates through which a subject vehicle needs to travel, and approximating, by polynomials, a longitudinal position and a lateral position of the subject vehicle based on the plurality of sets of coordinates to generate a reference route represented by the polynomials, each of the polynomials being a function of a route length from a preset reference point;
calculating a planned traveling distance that is a distance that the subject vehicle needs to travel in a unit time of a predefined length;
calculating a target position that is a target value of a position of the subject vehicle after the unit time, based on the polynomial of the longitudinal position of the subject vehicle, the polynomial of the lateral position of the subject vehicle, and the planned traveling distance; and
controlling an actuator of the subject vehicle so that an error between the position of the subject vehicle after the unit time and the target position is reduced,
wherein the point-series information includes information on a yaw rate at which the subject vehicle needs to travel at each of the plurality of sets of coordinates,
the processor further approximates the yaw rate at which the subject vehicle needs to travel at each of the plurality of sets of coordinates by a polynomial that is a function of the route length from the reference point,
the processor further calculates a target yaw rate that is a target value of a yaw rate of the subject vehicle after the unit time, based on the polynomial of the yaw rate at which the subject vehicle needs to travel, and the planned traveling distance, and
the processor further controls the actuator of the subject vehicle so that an error between the yaw rate of the subject vehicle after the unit time and the target yaw rate is reduced.

12. The vehicle control device according to claim 11,
wherein the processor calculates a plurality of planned traveling distances corresponding to a plurality of times at intervals of the unit time from a current time, the plurality of planned traveling distances including the planned traveling distance,
the processor calculates a plurality of target positions corresponding to the plurality of times, based on the plurality of planned traveling distances, the plurality of target positions including the target position, and
the processor controls the actuator of the subject vehicle so that a cumulative total of errors between positions of the subject vehicle corresponding to the plurality of times and the plurality of target positions corresponding to the plurality of times is reduced, the positions of the subject vehicle being calculated using a motion model of the subject vehicle and including the position of the subject vehicle.

13. The vehicle control device according to claim 11,
wherein the processor calculates the planned traveling distance based on at least one of a speed and a target speed of the subject vehicle.

14. The vehicle control device according to claim 11, further comprising
a storage in which information on a predicted speed of the subject vehicle is stored, the predicted speed being calculated when the processor determines the error between the position of the subject vehicle after the unit time and the target position,
wherein the processor calculates the planned traveling distance based on the information stored in the storage.

15. The vehicle control device according to claim 11,
wherein the point-series information includes information on a speed at which the subject vehicle needs to travel at each of the plurality of sets of coordinates,
the processor further approximates the speed at which the subject vehicle needs to travel at each of the plurality of sets of coordinates by a polynomial that is a function of the route length from the reference point, and
the processor calculates the planned traveling distance based on the polynomial of the speed at which the subject vehicle needs to travel.

16. The vehicle control device according to claim 11,
wherein the point-series information includes information on an azimuth angle at which the subject vehicle needs to travel at each of the plurality of sets of coordinates,
the processor further approximates the azimuth angle at which the subject vehicle needs to travel at each of the plurality of sets of coordinates by a polynomial that is a function of the route length from the reference point,
the processor further calculates a target azimuth angle that is a target value of an azimuth angle of the subject vehicle after the unit time, based on the polynomial of the azimuth angle at which the subject vehicle needs to travel, and the planned traveling distance, and
the processor further controls the actuator of the subject vehicle so that an error between the azimuth angle of the subject vehicle after the unit time and the target azimuth angle is reduced.

17. The vehicle control device according to claim 11,
wherein the point-series information includes information on a road curvature at each of the plurality of sets of coordinates,
the processor further approximates the road curvature at each of the plurality of sets of coordinates by a polynomial that is a function of the route length from the reference point,
the processor further calculates a target steering angle that is a target value of a steering angle of the subject vehicle after the unit time, based on the polynomial of the road curvature and the planned traveling distance, and
the processor further controls the actuator of the subject vehicle so that an error between the steering angle of the subject vehicle after the unit time and the target steering angle is reduced.

18. The vehicle control device according to claim 11,
wherein the processor calculates a plurality of planned traveling distances corresponding to a plurality of unit times that are different in length, the plurality of unit times including the unit time, and
the processor selects one of the plurality of planned traveling distances according to a parameter for which a target value is calculated, and uses the selected one of the plurality of planned traveling distances.

19. The vehicle control device according to claim 11,
wherein each of the plurality of sets of coordinates is a set of three-dimensional coordinates including information on an altitude, and
the route length and the planned traveling distance are three-dimensional distances.
